(19) United States
(12) Patent Application Publication
(10) Pub. No.: US 2005/0137968 A1
(43) Pub. Date: Jun. 23, 2005

(54) System and method for internet based marketing and information management for mortgage loans

(76) Inventor: Scott Mitchell, Freehold, NJ (US)

Correspondence Address: LESLIE GLADSTONE RESTAINO;BROWN RAYSMAN MILLSTEIN & STEINER LLP, 163 MADISON AVENUE, PO BOX 1989, MORRISTOWN, NJ, 07962-1989, US

(21) Appl. No.: 11/011,555

(22) Filed: Dec. 13, 2004

Related U.S. Application Data
(60) Provisional application No. 60/532,125, filed on Dec. 22, 2003.

(51) Int. Cl. G06F 17/60

(52) U.S. Cl. 705/38

(57) ABSTRACT

The present invention generally provides systems and methods for processing loans and generating leads for loans. Loans are generally processed by receiving at least one lead relating to one or more individuals interested in obtaining a loan from a registered user, assigning the lead to a loan officer, which may either accept and decline the assignment, and reassigning the lead to another loan officer if a previous assigned loan officer declines the lead. The status of the loan process may be tracked the loan application process. Such leads may be generated by a comparison between at least one term of a closed loan with at least one term of another loan, in which instance, the lead is generated based on a determination as to whether a borrower of the closed loan would benefit from a refinance of the closed loan.

### RELATED APPLICATIONS

This application claims the benefit of U.S. Provisional application Ser. No. 60/532,125, filed on Dec. 22, 2003, and entitled “Home Loan Desk,”the contents of which are hereby incorporated by reference herein.

### BACKGROUND OF THE INVENTION

The present invention relates to an Internet based marketing and information management system and method for real estate acquisition and mortgage loan origination.

A number of real estate and mortgage loan origination systems are currently available. Real estate systems generally allow a user to search real estate listings with the interface provided therewith and some include links to loan providers. Loan providers generally provide an interface for uses to review loan information and some provide interfaces for user to apply for loans online. These systems however do not provide much in terms of data sharing between real estate professionals and loan originators, if any. Accordingly there is a need for systems that allow such individuals to share information between each other.

### SUMMARY OF INVENTION

In one aspect of the invention, a computer implemented method for processing loans is provided that includes the steps of receiving at least one lead relating to one or more individuals interested in obtaining a loan from a registered user, storing data relating to the at least one lead in a database, assigning the at least one lead to a loan officer, which is presented with an option to one of accept and decline the assignment, reassigning the lead to another loan officer if a previous assigned loan officer declines the lead, and tracking a status with regard to the loan application throughout a loan process.

In another aspect of the invention, a method for web-based loan marketing is provided that includes the steps of receiving loan information of at least one closed loan, such as at least one term of the closed loan, comparing the at least one term of the closed loan with at least one term of another loan, determining based on the comparison whether a borrower of the closed loan would benefit from a refinance of the closed loan, and generating a lead for a loan based on the determination.

### BRIEF DESCRIPTION OF DRAWINGS

The foregoing and other aspects of the invention will become more readily apparent from the following description of illustrative embodiments thereof and the accompanying drawings, which illustrate the invention in an exemplary and non-limiting fashion, and in which like or similar references in the different figures indicate the same, similar or corresponding items:

FIG. 1 is a block diagram of a system for marketing mortgage loans according to an embodiment of the invention;

FIG. 2 is a flow chart of a method for processing a loan according to an embodiment of the invention;

FIG. 3 is a flow chart of a method for managing clients according to an embodiment of the invention;

FIG. 4 is a flow chart of a method for following unsuccessful leads according to an embodiment of the invention;

FIG. 5 is a flow chart of a method for accounting according to an embodiment of the invention;

FIG. 6 is a screenshot of an interface for entering and editing information according to an embodiment of the invention;

FIG. 7 is a screenshot of an interface for uploading an image according to an embodiment of the invention;

FIG. 8 is a screenshot of a search interface according to an embodiment of the invention;

FIGS. 9-11 are screenshots of an interface for entering affiliate website information according to an embodiment of the invention;

FIG. 12 is a screenshot of an interface for verifying information according to an embodiment of the invention;

FIGS. 13-14 are screenshots of an interface for viewing a report of affiliate websites according to an embodiment of the invention;

FIG. 15 is a screenshot of an interface for entering lead information according to an embodiment of the invention;

FIGS. 16-17 are screenshots of an interface for manually assigning loans according to an embodiment of the invention;

FIG. 18 is a screenshot of an interface for accepting an assigned loan according to an embodiment of the invention;

FIGS. 19-20 are screenshots of an interface for editing lender information according to an embodiment of the invention;

FIGS. 21-25 are screenshots of an interface lead and loan tracking according to an embodiment of the invention;

FIGS. 26-33 are screenshots of an interface for a supervisor to track lead and loan status and outcomes according to an embodiment of the invention;

FIG. 34-35 are screenshots of an interface for tracking activity on affiliate websites according to an embodiment of the invention;

FIG. 36 is a screenshot of an interface for a report view of loan officer assignment frequency according to an embodiment of the invention;

FIGS. 37-39 are screenshots of an interface for administering a rewards program according to an embodiment of the invention; and

FIGS. 40-42 are screenshots of an interface for administering the system according to an embodiment of the invention.

### DETAILED DESCRIPTION OF ONE EMBODIMENT

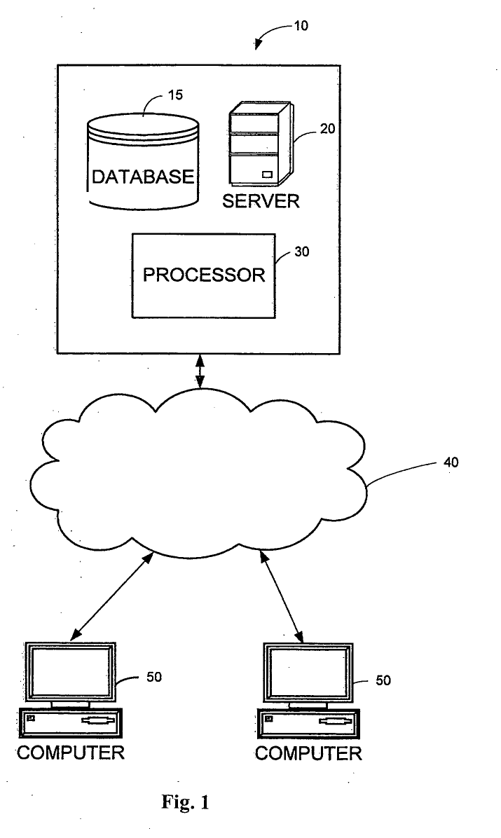

Referring to FIG. 1, a computer system 10 for marketing mortgage loans may include one or more of the following: a database 15, server 20, and processor 30. The database 15 can be one or more storage devices, suitable for storing data described herein. The server 20 can be any component that is capable of running and supporting software to carryout the modules and functionality described herein, such as an SQL server. The processor 30 can be any component that is capable of processing data and information to provide the functionality as described herein, which may be included in one or more of the servers 20 or may be part of a separate computer.

In one embodiment, the system 10 is communicatively coupled over a network 40 to client computers 50. The network 40 can be a local area network (LAN), wide area network (WAN), Internet, or any other network capable of communicating information and data from the system 10 to client computers 50, which may be local or remote. The system 10 may be accessed by a plurality of computers 50, each of which can be any computer device known in the art, for example, a personal computer including components such as a memory device, an input component, such as a keyboard and mouse, a display, and a central processing unit. The computer 50 may also be a laptop, personal digital assistant (PDA), handheld device, such as a mobile telephone or BlackBerry™ or other device capable of receiving data and sending the data over network 40 to the system 10. In general, the client computers 50 have a web browser for receiving and viewing documents written in the Hypertext Markup Language (HTML) and transmitted over the network 40 via Hypertext Transfer Protocol (HTTP) and transmitting requests for HTML documents to the system 10 via HTTP, or any other software for displaying interfaces with information provided from a remote computer, such as server 20.

In general, the invention described herein relates to a web-based marketing and information management method and system, and is specifically described by way of example in connection with mortgage loans or other real estate related financial products. However, the method and system described herein can also be applied to other industries and products, for example telemarketing, financial services, direct marketing, revenue sharing and commission-based sales, and other industries, and is thus not limited thereto.

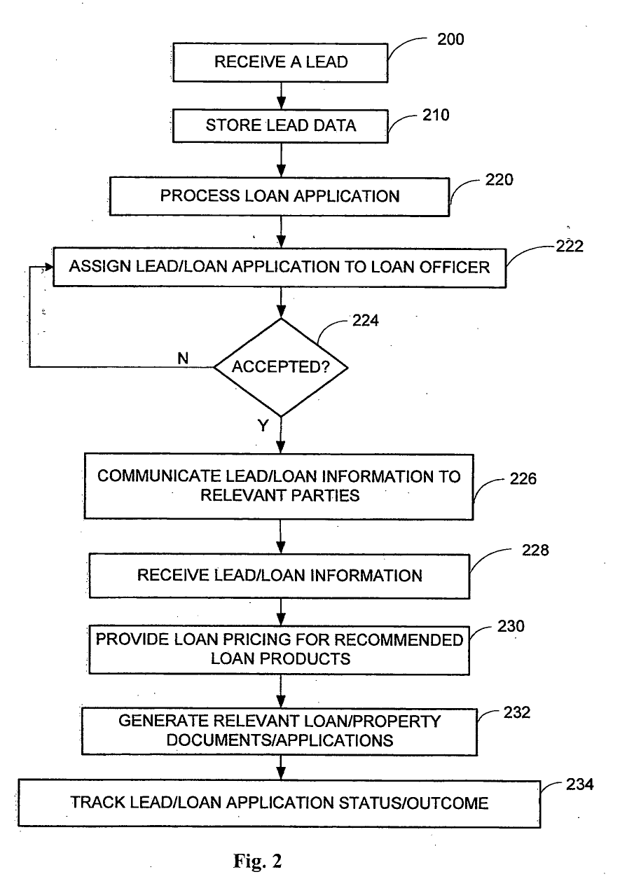

Referring to FIG. 2, a computer implemented method for processing a loan according to one embodiment of the invention begins with receiving a lead at step 200. In general, leads are information or indicators relating to individuals who are interested in obtaining a mortgage loan or any other type of product or service. A lead can be acquired in several ways. For example, individuals interested in a mortgage loan may indicate their interest by entering information indicating as such into a website, such as a mortgage site, which feeds data to the system. Leads may also be obtained internally, for example, from loan officers, company events, through telemarketing and other marketing, such as via e-mail, direct mail campaigns, or marketing events, through referrals from past clients, e.g., via the Client Maintenance Module, further described herein, or from related franchises or subsidiaries. Leads may also be obtained externally, such as via third parties, lead generation sites, or other entities, companies, individuals, or organizations, such as realtors, builders, financial planners, accountants, attorneys, non-profit organizations or other partner entities. In either event, information relating to a lead, such as the interested party's contact information, information regarding the property and loan interested in, etc., may be stored, e.g., in a database, at step 210.

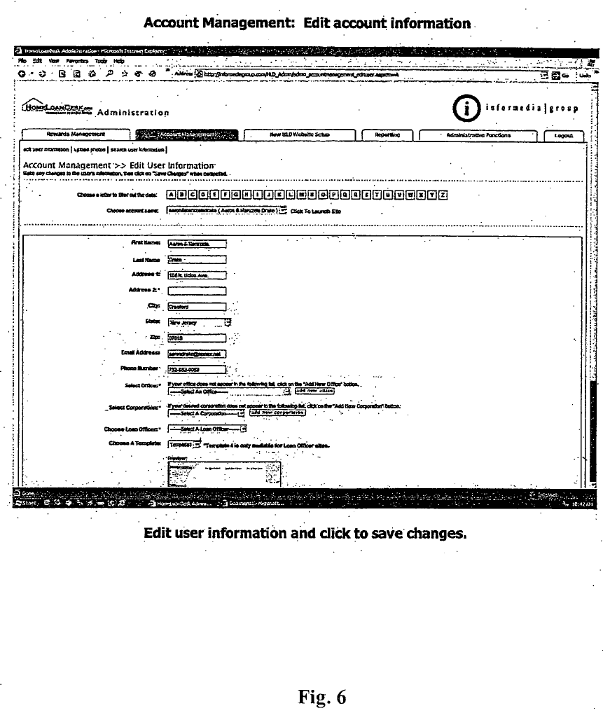

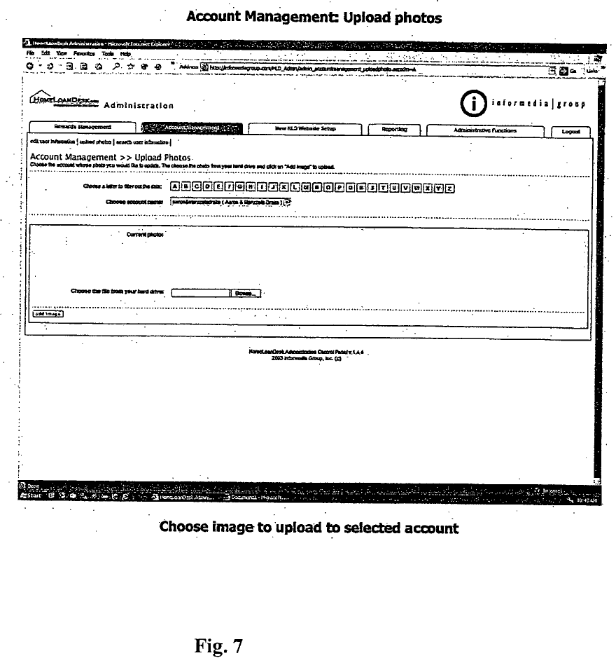

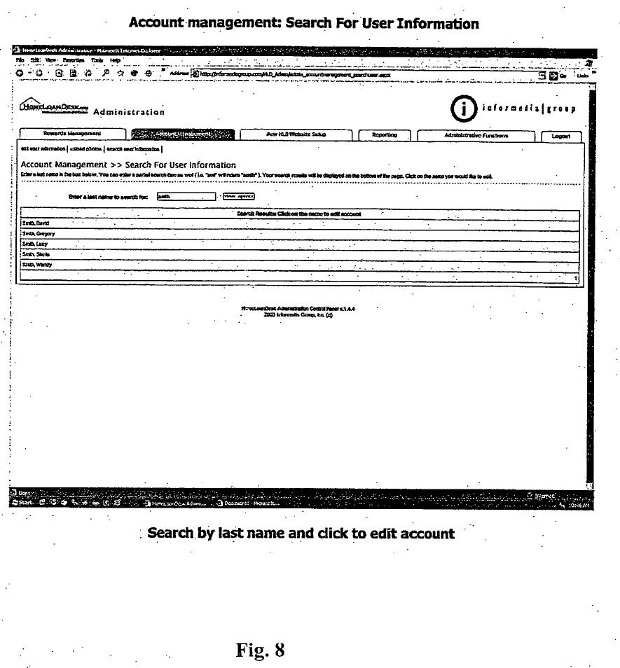

In one embodiment of the invention, each internal employee and external affiliate that provides lead information must be a registered user of the system and may register with a registration interface that includes form elements for users to enter user information, such as with the interfaces depicted in FIG. 6-7. Data entered into the user registration interface can include, for example, name, contact information, affiliate office or corporation, preferred loan officer or other individual, template preferences and photographs, e.g., of properties to be listed or of the individual user. Following registration, a user can easily review their user information by logging into the system or searching the system, e.g., in a website such as that depicted in FIG. 8.

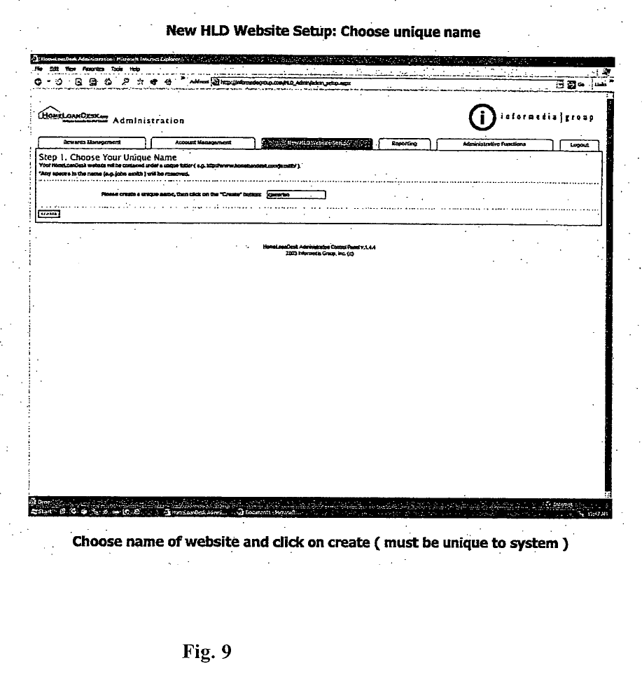

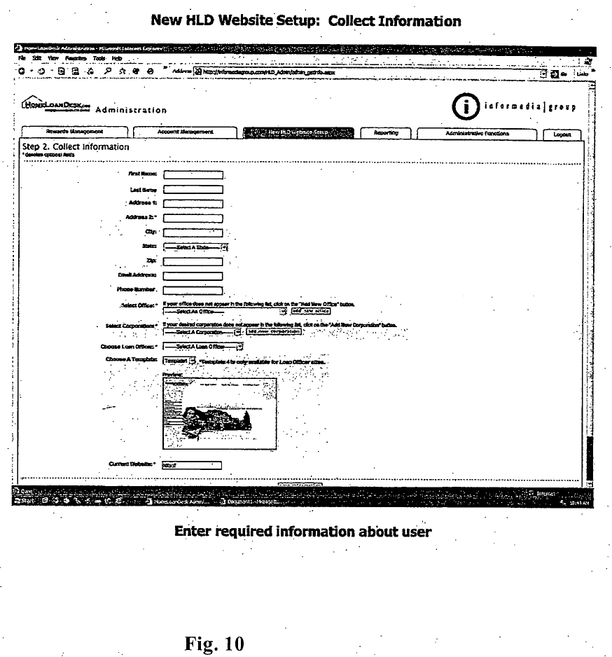

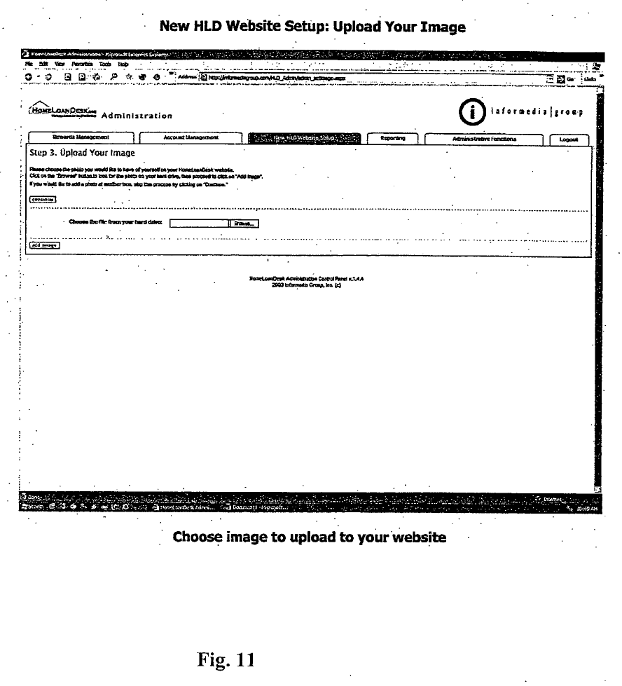

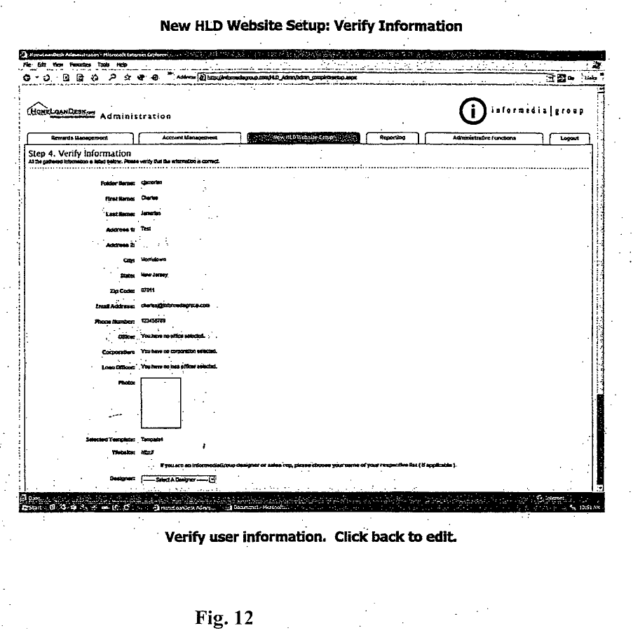

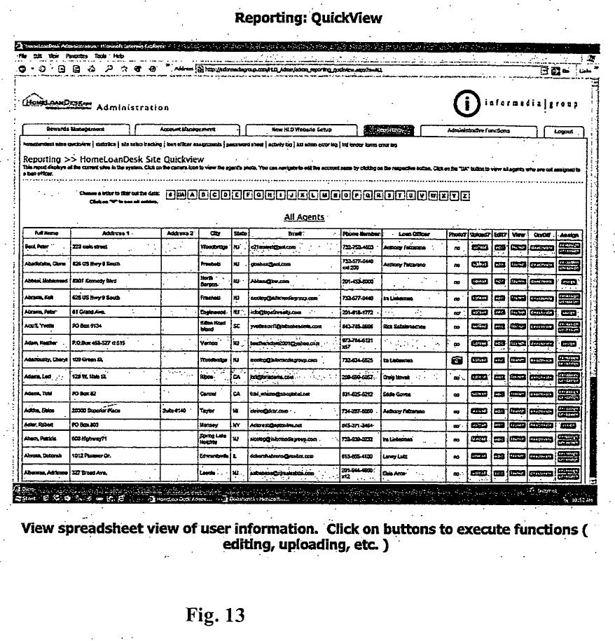

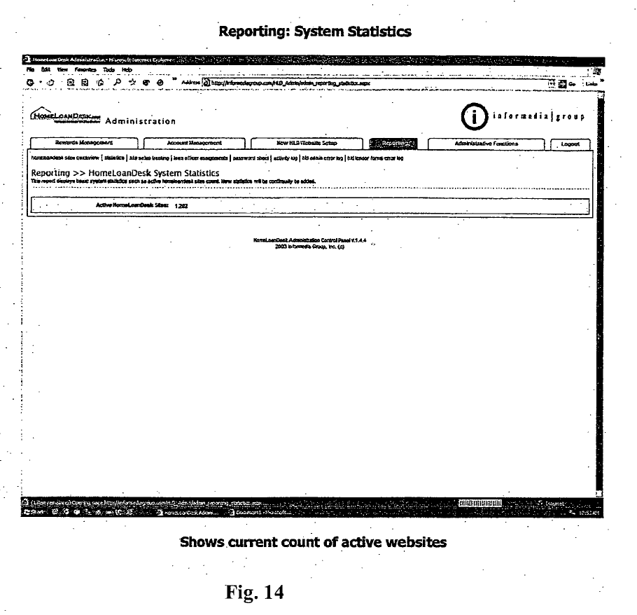

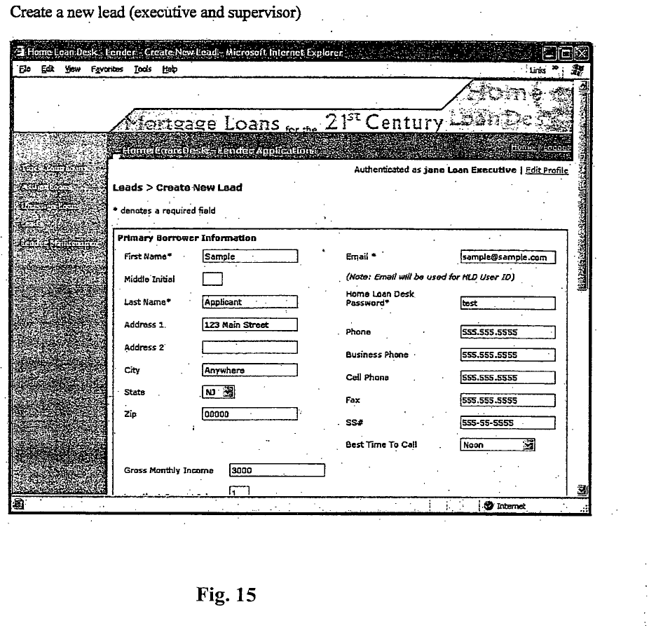

In one embodiment, leads supplied to the system are provided with websites of related affiliates. In one embodiment, the lead information is provided in a custom format, such as in accordance with a geographical location or market segment. An affiliate website can be created using an affiliate website creation interface provided by the system 10. For example, a registered user may create an affiliate website by specifying a unique name for the affiliate website which may be entered into the screen depicted in FIG. 9 and information relating to the affiliate user may be entered in a screen such as that depicted in FIGS. 10-11. The data or information relating to the affiliate user entered into the affiliate website registration screens of FIGS. 10-11, can include, for example, name, contact information, affiliate office or corporation, preferred loan officer or other individual, template preferences and photographs, e.g., of a property, corporation or individual. The user has the opportunity to verify the information in a screen, such as that depicted in FIG. 12. Each of the registered affiliate users and websites can be viewed by a system administrator or other user, such as in the reporting views depicted in FIGS. 13-14. Affiliate users may generally use the affiliate websites for their real estate related businesses. For example, real estate brokers may create an affiliate website to market properties listed with the broker. Information for parties interested in the listed properties, such as parties that made an offer for the property, may be communicated to the system as a lead. This aspect of the invention generally allows for the creation and/or maintenance of a network of websites for securing mortgage leads and applications from a variety of sources, such as through realtors and other real estate professionals, such as builders, financial planners, accountants, attorneys, non-profit organization, etc., providing loan related services, by providing website creation and/or web hosting services thereto. The affiliate website, e.g., a webpage, may therefore include at least one form element or other means for collecting information for generating a lead, such as the name and contact information for an individual that may be interested in a loan, e.g., to finance a property in connection with the services provided by the affiliate.

In one embodiment, affiliate sites are set up individually or as part of two or three tier structures. For example, a two-tier structure includes a number of sites subordinate to a senior or “office” site, which offers access to tracking for all leads or loans generated on any subordinate site. A three-tier organization would add a third or “corporate” level with access to all loans generated through subordinate “office” or individual sites.

In one embodiment, lead data may be entered into a website, such as that depicted in the screenshot shown in FIG. 15. As shown in FIG. 15, lead data (such as name, contact information, income and other data) relating to an individual interested in a mortgage loan is entered into a screen that includes form elements for specifying lead data to be stored to the database. Any registered user of the system 10, such as a loan officer, a real estate agent, etc, may provide the data, as well as interested parties.

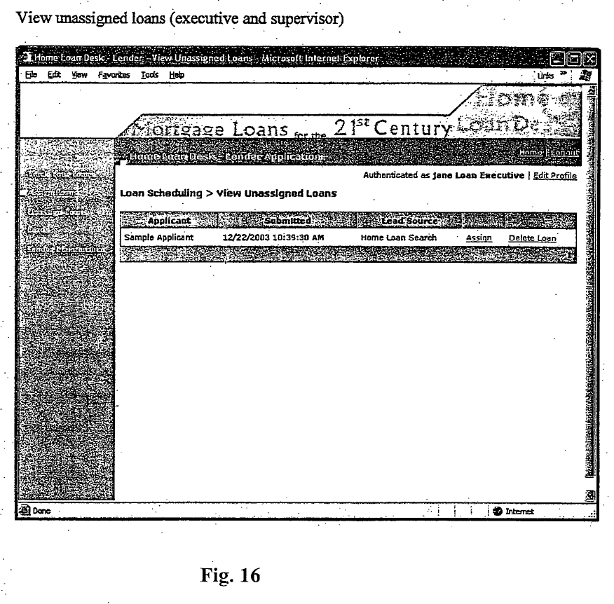

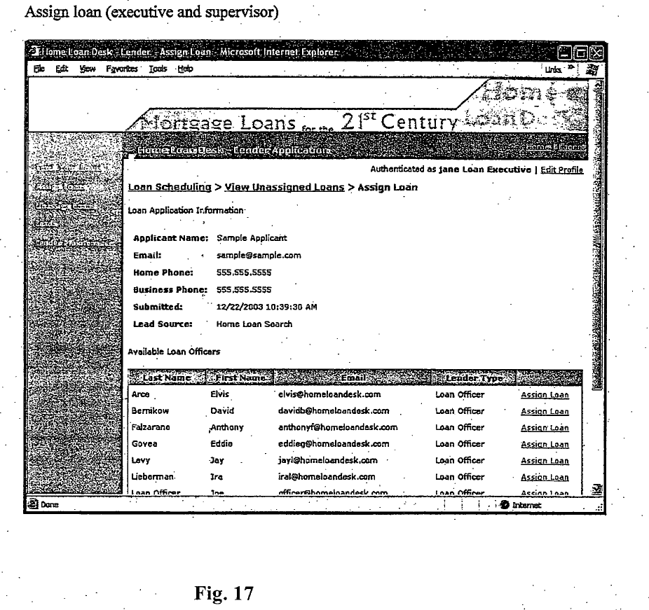

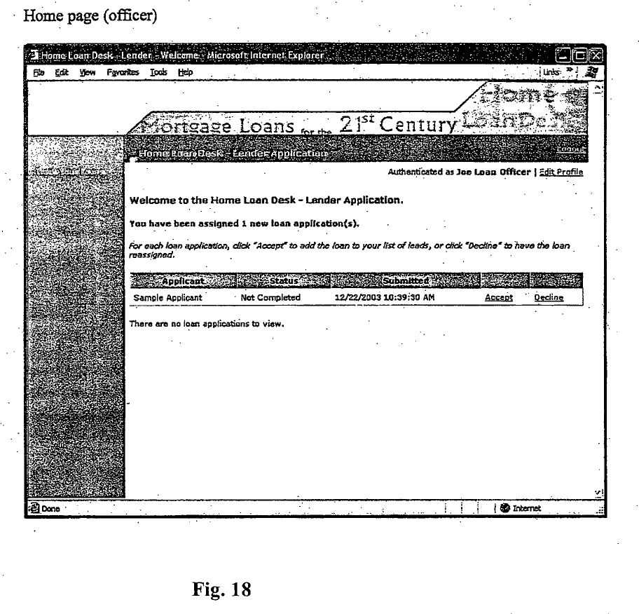

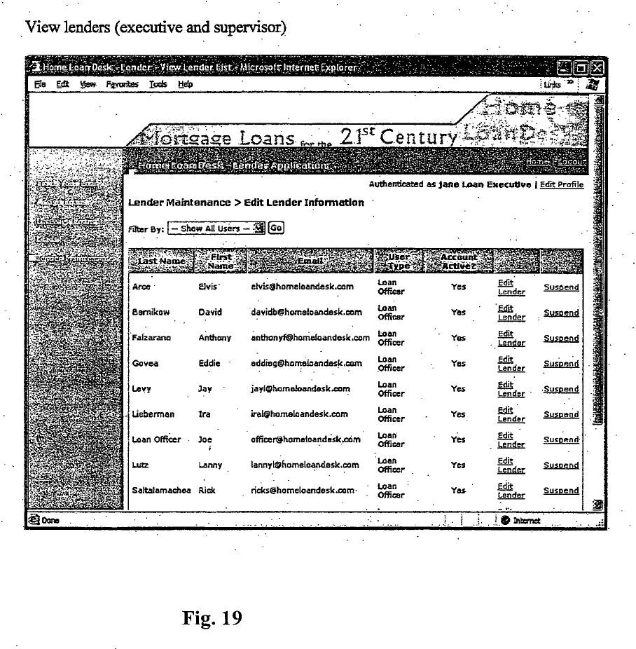

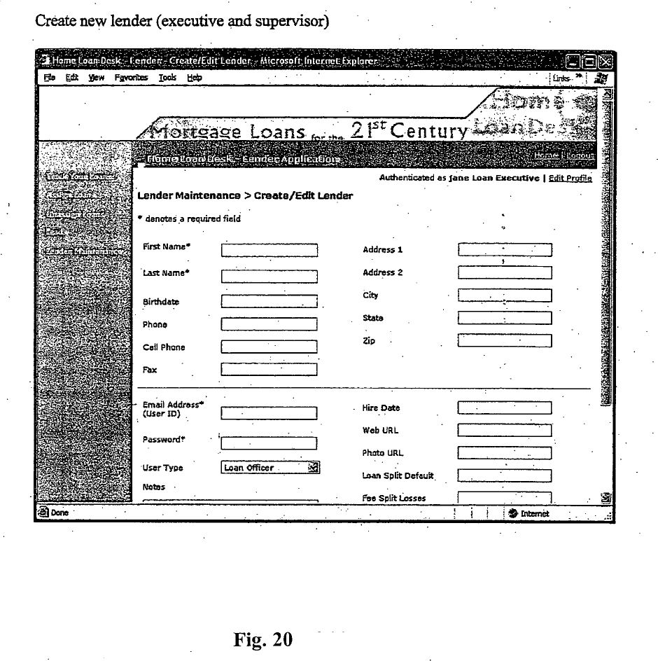

Referring again to FIG. 2, the stored data may be used to process a mortgage loan application, step 220. The loan application may be processed in a variety of ways. In one embodiment, loan processing begins by assigning a lead and/or a loan application to a loan officer, step 222. The loan assignment can be an automatic assignment in accordance with assignment parameters, or a manual assignment, e.g., by an administrator or other system user. An automatic assignment of a lead or loan may be based on one or more parameters, such as location of the property or the parties, the type of property, loan size, type of loan, completeness of lead, staffing, marketing partner/franchisee obligations, preferences provided by the lead generator, or any other parameter. In this respect loan/lead assignment may generally be applied to match an appropriate loan officer, e.g., based on experience, skill, preferences, etc., to a lead. For example, loan officers with experience with mortgages for commercial properties may preferentially be assigned to leads for such loans. Alternately the system may be set to allow for manual assignment of leads by a human scheduler. An example of a user interface for manually assigning a loan is depicted in FIGS. 16-17. In some embodiments, the assigned loan officer has an option to accept or decline the loan and/or the associated lead, e.g., in the user interface as shown in FIG. 18. If a lead is declined, the lead is returned for scheduling, step 224. Upon assignment of a lead and/or loan, any individuals or entities associated with the assigned lead/ loan application, such as the interested party, the real estate agent, loan officer, the party providing the lead, the lender or lenders, etc., are sent information regarding the lead or the loan application, for further attention, step 226. For example, a borrower may be sent welcome information and information regarding the loan officer assigned to the lead. Similarly, a loan officer, e.g., for a mortgage broker or lender, may be sent information regarding the borrower for further attention, e.g., to complete the loan application. The loan officer can view and/or edit lender information, for example, in the screens depicted in FIGS. 19-20.

In general, processing the loan may include providing the interested party with loan terms, completing loan arrangements, and closing of the loan, but need not result in the loan closing. For example, any point in the loan process is included in processing the loan.

In one embodiment, at each stage of the loan process, relevant information is entered into or modified in the system an appropriate user, step 228. Based on the lead and/or loan information entered into the system, the system automatically provides loan pricing and generation of recommended programs or products for each lead based on parameters available to the system, step 230. In one embodiment, the system automatically prepares documents or applications relevant to the loan or property, such as an application or an order for credit reports, title searches, property appraisal, good faith estimates, closing statements and other items related to the loan based upon the entered loan information, by sending such requests to affiliates or vendors, step 232. In one embodiment, the system stores state and local regulatory requirements to provide accurate and through documentation. In addition, the system stores fee schedules for various products, items and locations, thus allowing loan pricing and documents to be default populated with the standard charges.

The system tracks the lead/loan through the application process, step 234, and may generate status reports and status emails to send to all relevant parties as needed during the loan process. As a loan progresses, the loan will be transferred automatically to the correct department, individual or entity, e.g., a loan officer, processor, underwriter, etc., at an appropriate time. When the loan has closed, information relating to the loan is stored for uses, such as client maintenance, accounting and tracking. In addition, the system automatically triggers sending of certain items, for example, a closing gift or other reward for closing the loan, a customer satisfaction survey, or other item.

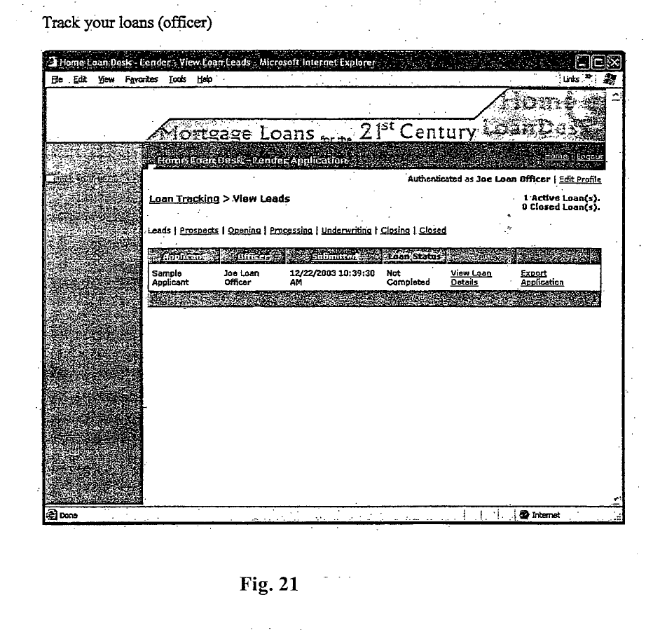

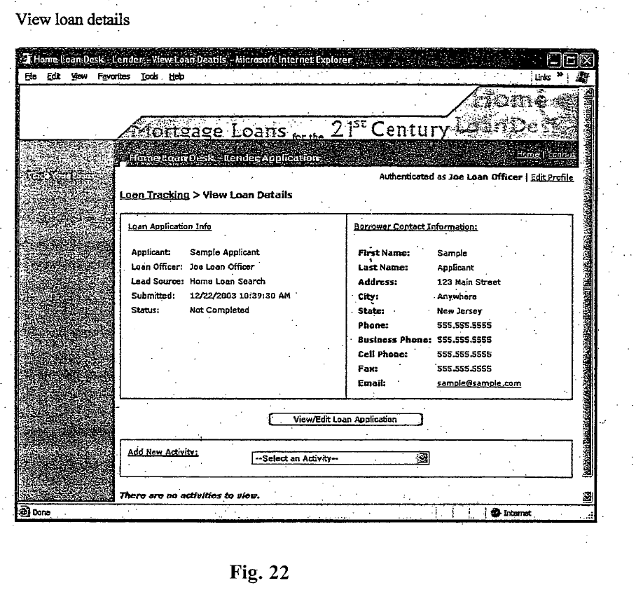

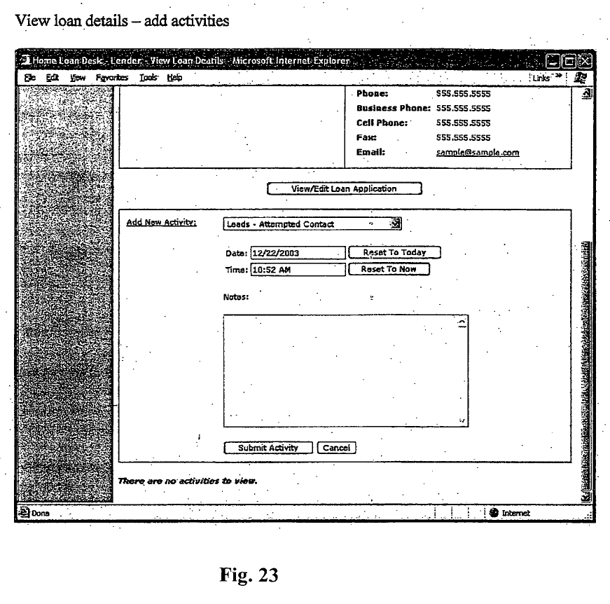

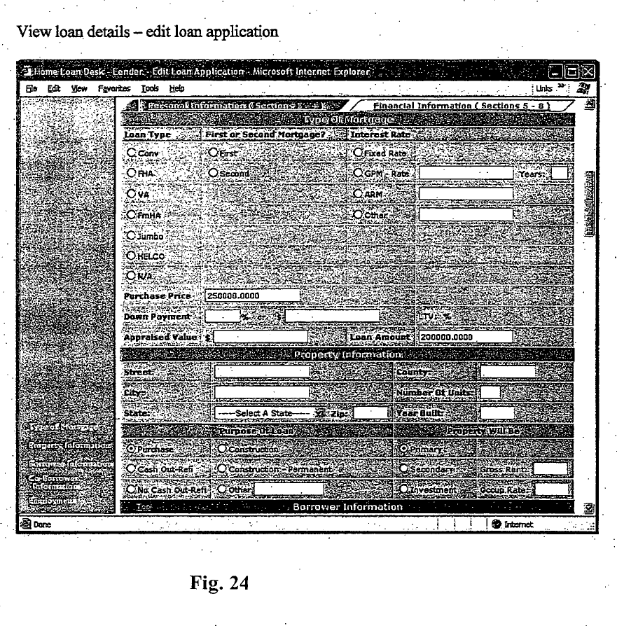

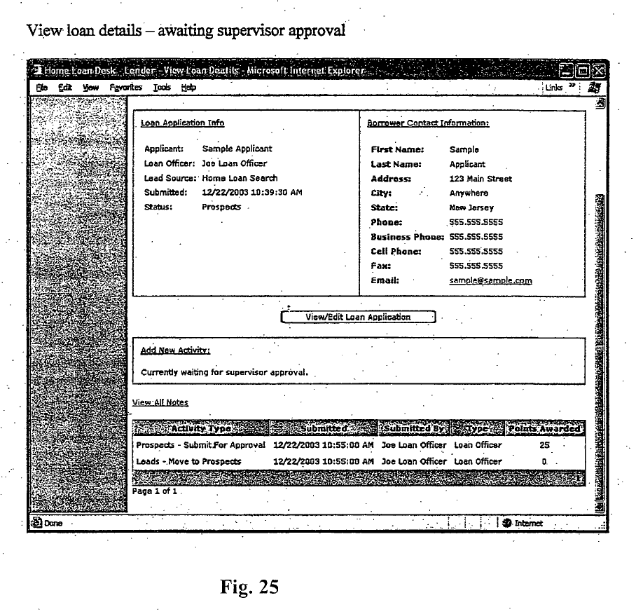

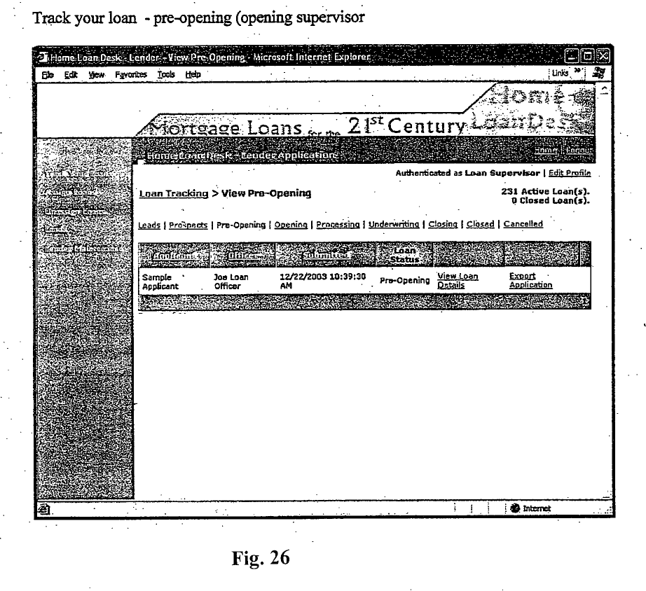

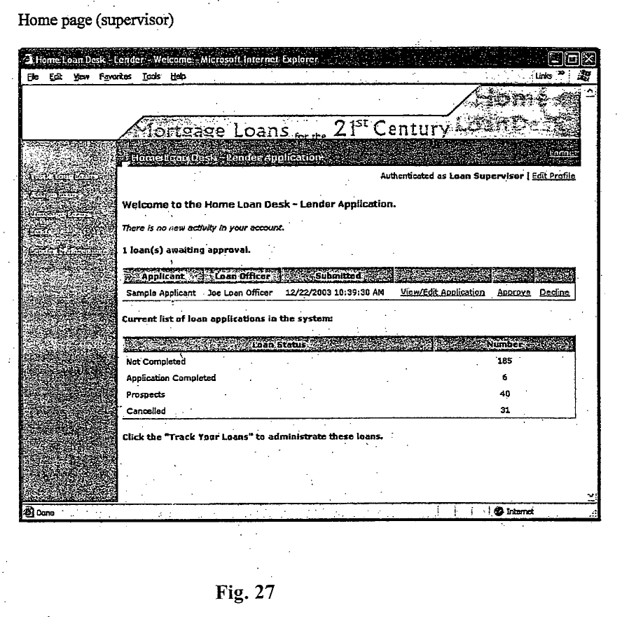

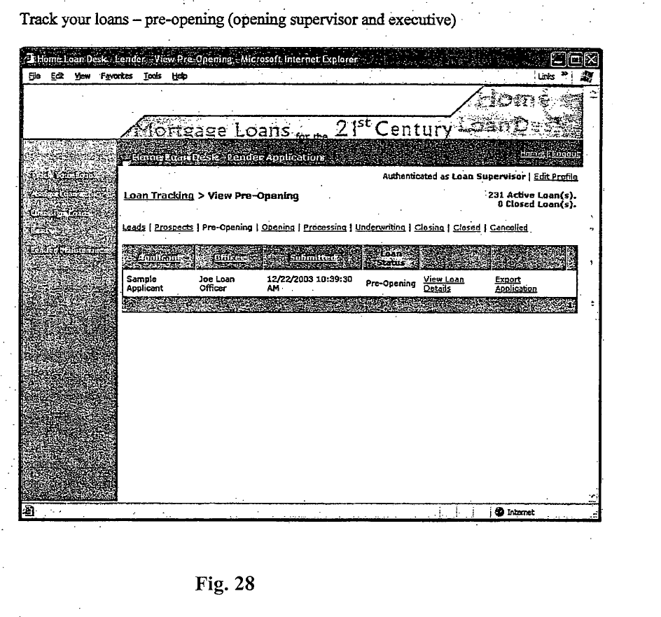

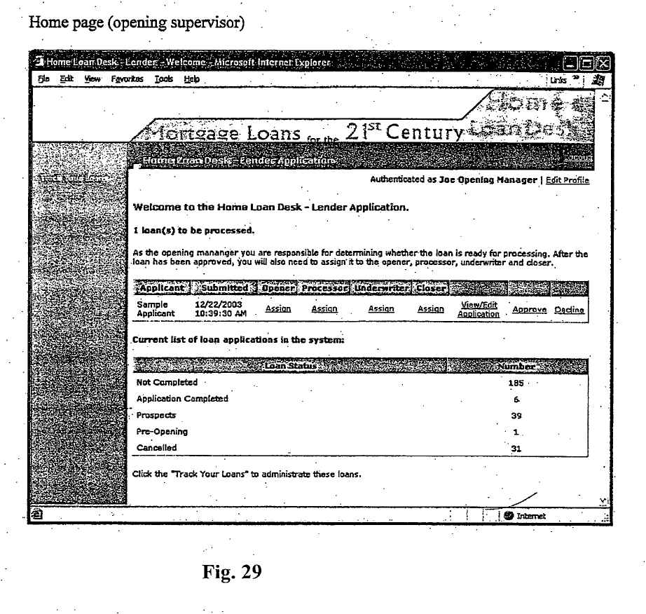

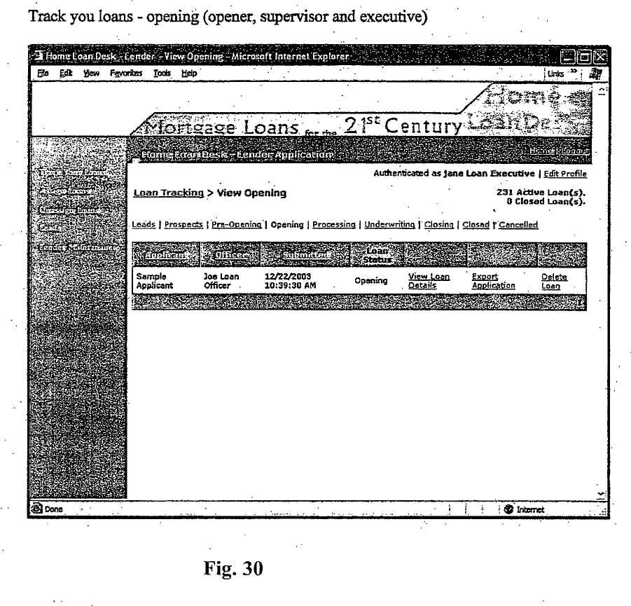

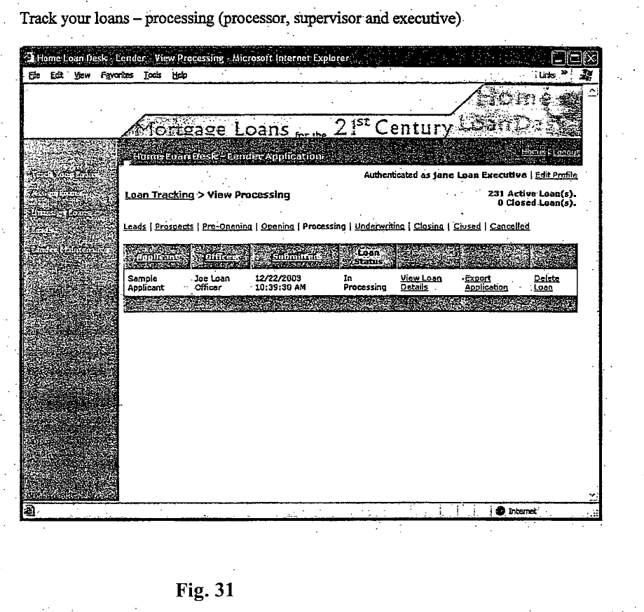

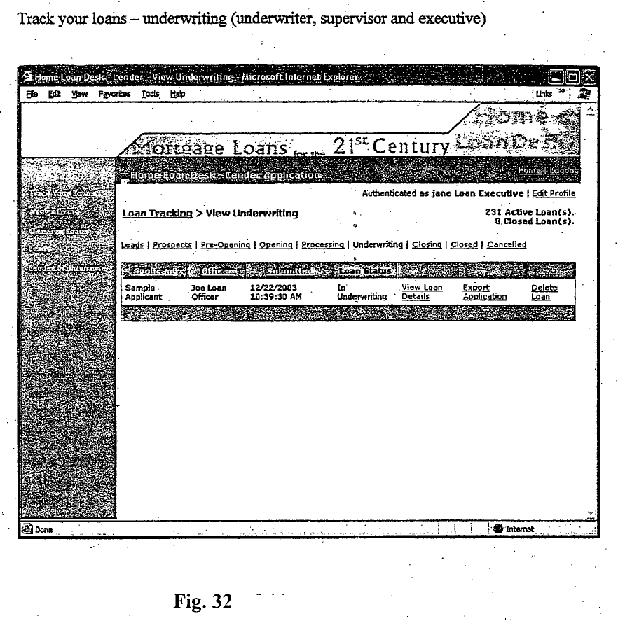

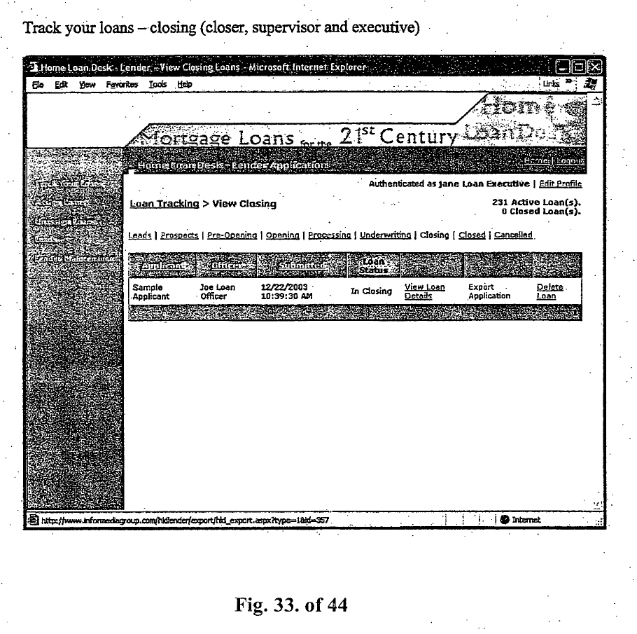

In one embodiment, all loans and leads are tracked in real time. Data tracked in connection with a lead or loan includes the following: time and date of contact attempts with relevant parties, communications to the relevant parties, e.g., welcome e-mails sent, credit checks, mailings, e.g., loan package sent out and received, appraisal ordered, title ordered, appraisal received, title received, loan sent to processing, loan sent to underwriting, closing date set, and other data relating to a loan transaction. For example, as depicted in FIGS. 21-25, leads, loan details and approval status can be tracked by a loan officer or other employee. In addition, a supervisor can track employee's lead and loan status and outcomes, for example, whether each lead or loan is in pre-opening, assigned, opened, in process, in underwriting, in closing, closed or completed, in screens such as those shown in FIGS. 26-33. Preferably, the tracked items are listed in a user interface that allows a user to select one of the listed items for additional information thereto.

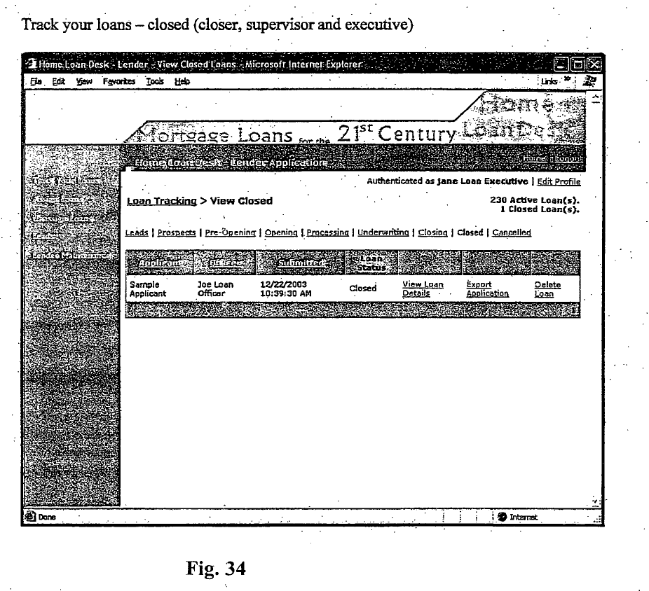

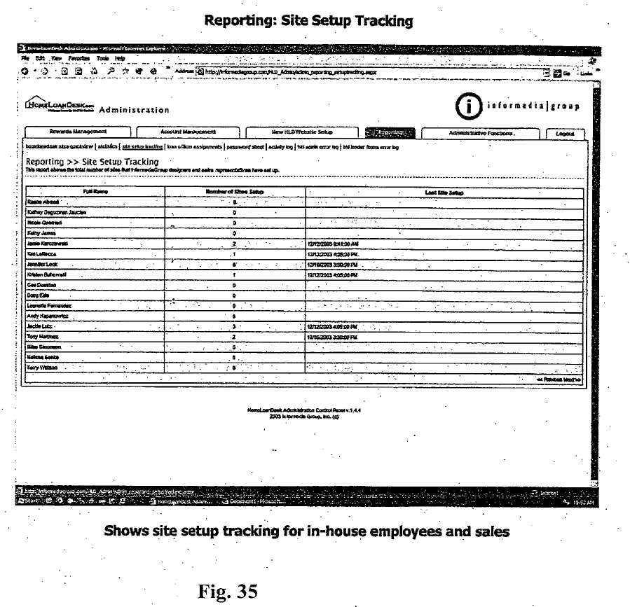

In some embodiments of the invention, loan activity on a base website is tracked. In other embodiments, loan activity on subordinate or senior websites is also tracked. The loan activity is tracked, for example, for data mining purposes, reporting, and analysis, e.g., of lead effectiveness, profitability, effectiveness of marketing efforts, and broker/employee performance. In one embodiment, loan activity can be tracked in real time, e.g., by authorized users including employees, affiliates and other authorized users in accordance with security settings. In this embodiment, a user, such as an affiliate, can log into the system and obtain a real time view of the status of a loan. In addition, activity on affiliate websites can be tracked, e.g., as shown in the screens of FIGS. 34-35. In one embodiment, the partners and affiliates can log into the system and track loan activity in real time.

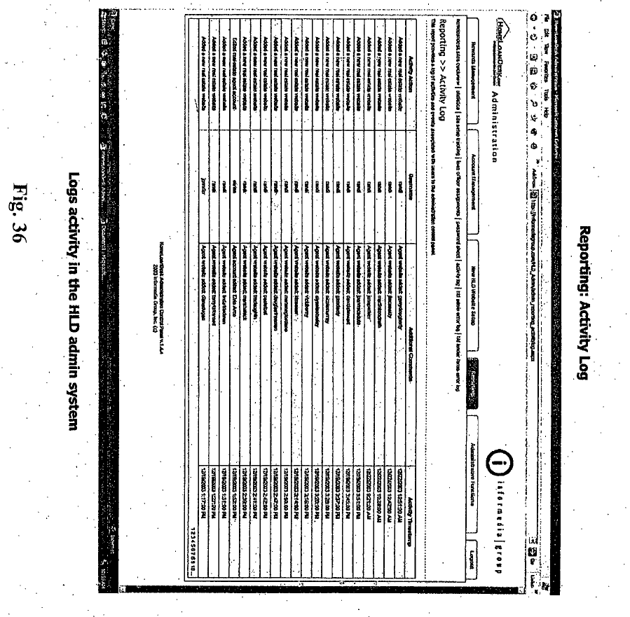

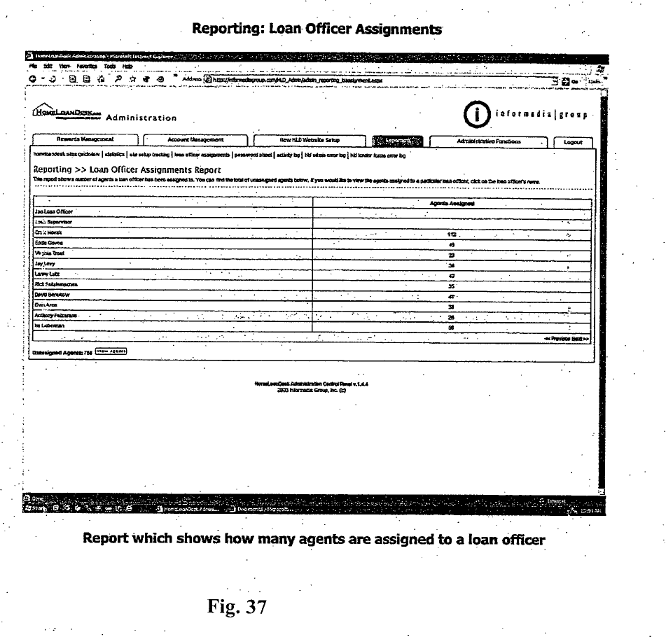

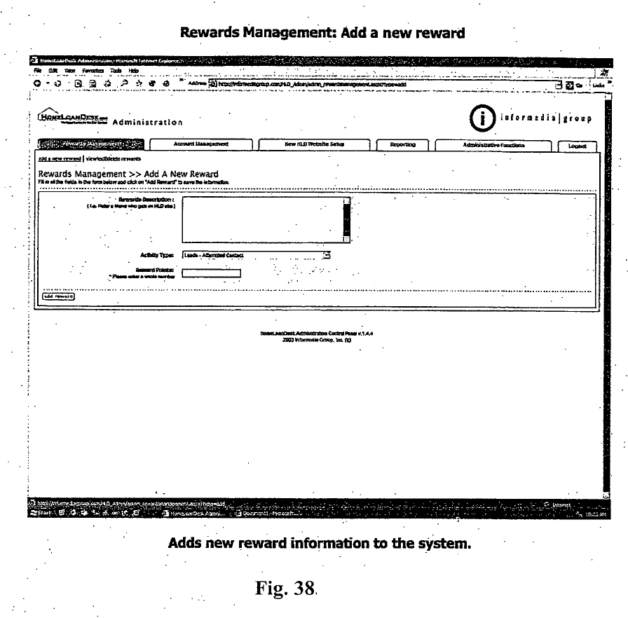

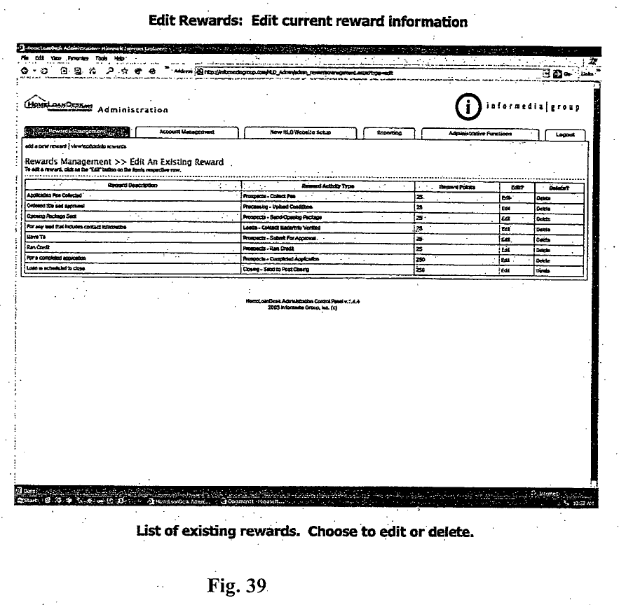

Tracking of loan activity is useful for determining the effectiveness of the system, leads, brokers, loan officers, brokers and other individuals related to the process or other aspects of the system. Information obtained in tracking loan activity can be used to generate a report, such as a report of lead effectiveness, closing percentages, broker success rates, loan officer or other employee success or other reports. For example, an indication of the success or relative popularity of a loan officer can be shown by the frequency the loan officer is assigned to an agent or realtor, such as shown in FIG. 36. In addition, tracking of loan activity can be used to provide reward programs to partners and affiliates, e.g., brokers or borrowers. Rewards can be administered automatically or by a system administrator, e.g., using the screens depicted in FIGS. 37-39.

Access to tracking information is organized based on a secure system, allowing each user the ability to see only the information that he or she is authorized to view. For example a site-partner may view all information regarding loans created on the partner site, but may not view confidential financial information for each lead, borrower, client or other individual. Similarly, a marketing partner or affiliate will be able to view only loans made on sites deployed under a marketing agreement. Access is restricted using conventional log in and other security measures.

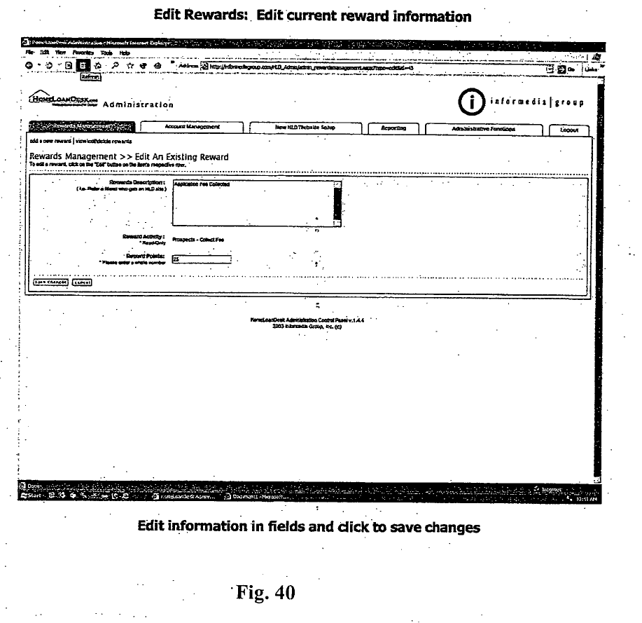

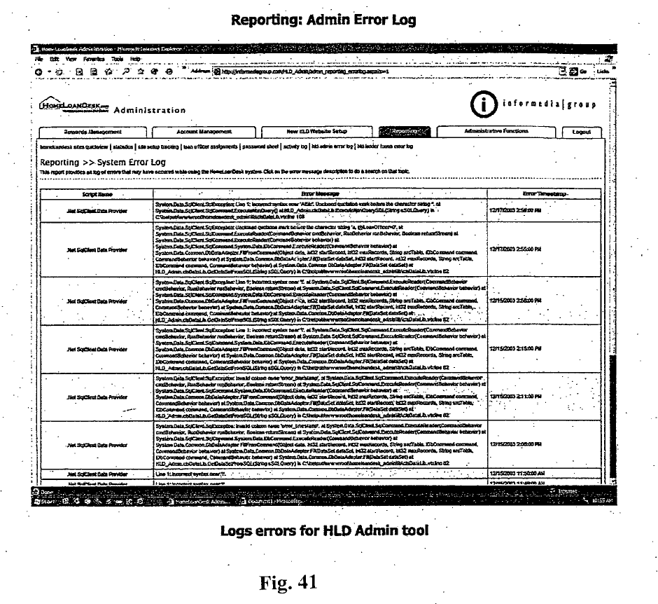

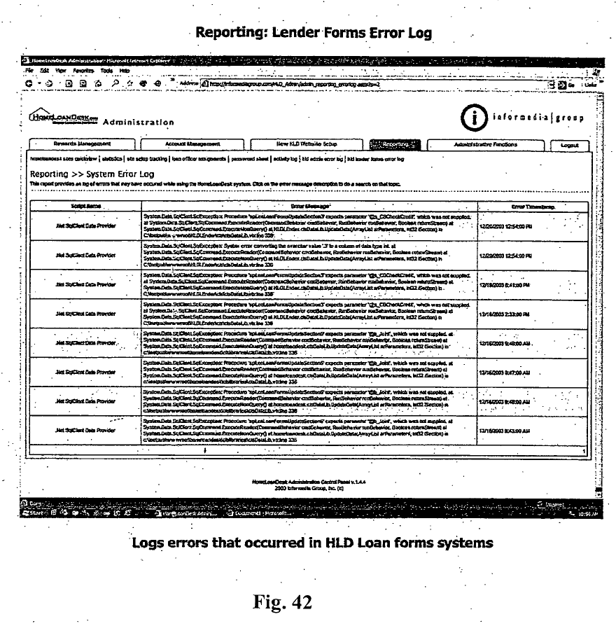

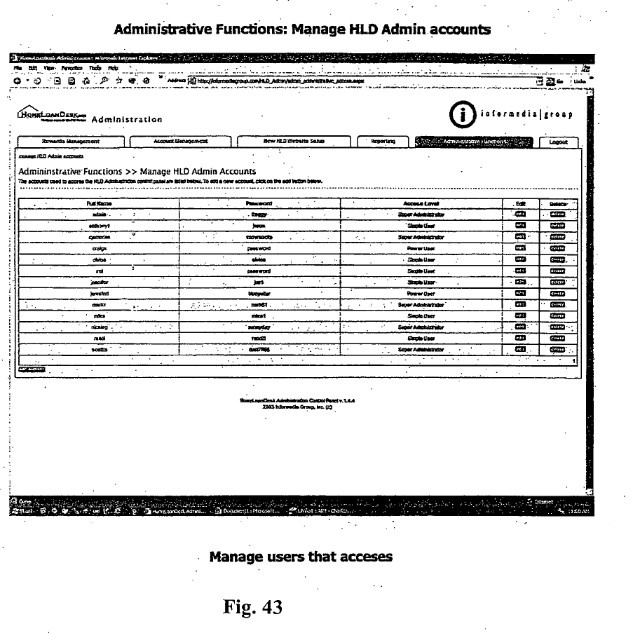

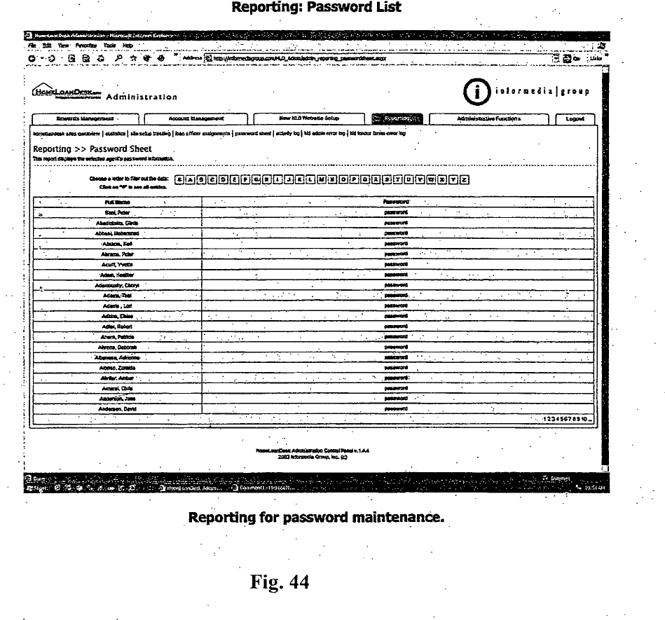

The system also provides an interface for a system administrator to administer the system and affiliate websites, e.g., errors in websites, setting administrative accounts and authorization settings, passwords, as shown in FIGS. 40-42.

Client Maintenance Module

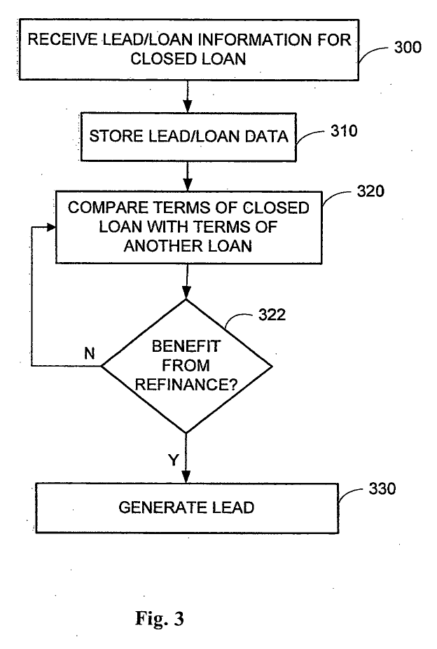

Referring to FIG. 3, in the event that a loan is successfully completed or closed, the lead and/or loan or other information associated with the loan is received by a Client Maintenance Module (CMM), step 300. The lead/loan data or other information may be stored in a CMM database, step 310. The CMM functionality generally provides maintenance of existing client relationships. For example, regular contact may be maintained in the form of messages or greetings, such as holiday cards, birthday greetings and special marketing messages, e.g., relating to new products or improved existing products. In addition the CMM follows the relevant market, e.g., mortgage rates, and automatically determines when a client may benefit from refinancing their mortgage. For example, the CMM system may compares the terms of a closed or an outstanding loan obligation, such as the interest rate, duration, fees, etc., with the terms of at least one other loan in this respect, step 320, and determines whether obtaining a new mortgage at a different interest rate or term would save the client money or would otherwise benefit the client, step 322. When a candidate for a mortgage refinance is identified by the CMM, the system generates lead information, a list of leads or other information pointing to the candidate, step 330. The lead information can be sent to a loan officer, telemarketer, affiliate or other individual or entity for follow up. The CMM can also generate lists of existing clients, e.g., for third party or affiliate offers and send messages to generate referrals for the lead.

Long Term Marketing Module

On occasion, leads or loan applications assigned to a loan officer may not have closed. In this case, the lead officer has not been successful in processing the loan and, thus, the system may automatically send the lead to a Long Term Marketing Module (LTMM).

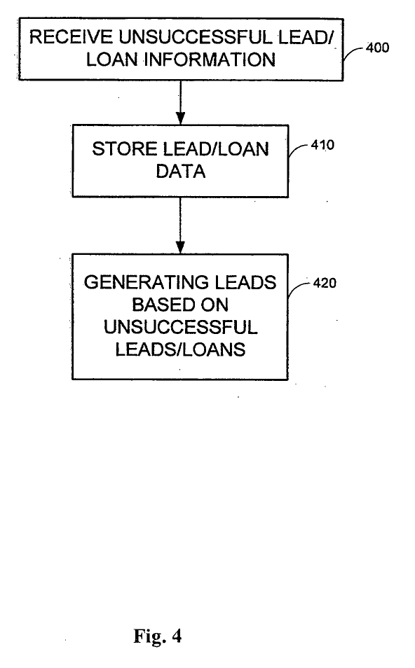

Referring to FIG. 4, the LTMM receives unsuccessful leads, and other leads, e.g., additional leads obtained from purchased lists of contacts or leads, step 400. Each lead is stored in the LTMM database, step 410. Lists of the stored leads are generated in accordance with one or more parameters, step 420. For example, a list of leads may be generated for use in sending regular marketing messages to each of the leads stored in the LTMM database. Such messages can comprise emails, faxes, letters, cards, or other messages. In other embodiments, a list of leads in the LTMM database is provided to telemarketers, either employees or affiliates, in accordance with various prioritization factors. Prioritization factors include, for example, time since last contact attempt, loan size, suitability analysis (e.g., a refinance lead would be reduced in priority if rates had risen since the lead was captured), customizable factors (e.g., set by a manager), such as location, type of loan, lead source, or other relevant factor. The telemarketers can contact the individuals associated with the lead, for example, to follow up on loan interest, if any.

Accounting Module

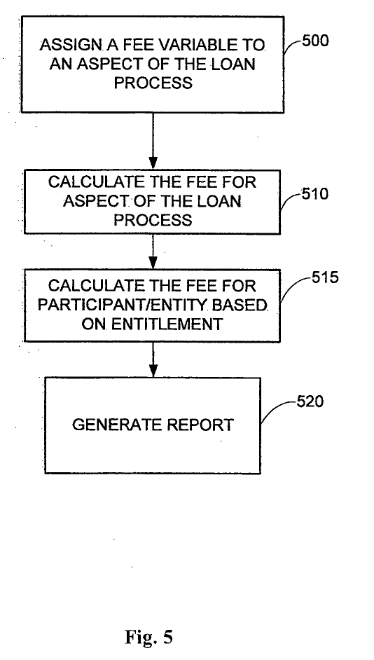

The system may also provide accounting functionality for calculating payments owed to each participant involved in processing the loan. Various types of payment schemes may be applied in accordance with the present invention. Referring to FIG. 5, in one embodiment, a fee variable, such as a fixed fee, a percentage of, e.g., the loan, a percentage of a fee or profit, etc., is assigned to at least one or each aspect of the loan process, step 500. For example, a fee variable may be assigned for obtaining a successful lead, for supervising a loan process, to third party affiliates, or other aspect of or individual related to the loan process. Data relating to revenue and/or expense of each loan may be received by an Accounting Module. The Accounting module generally calculates the fee due under each aspect of the loan process and also to each entity and individual under the various aspects of the loan process based on the entitlement and/or involvement in the loan process, step 510. The fee calculation may include applying an assigned fee percentage to revenue and/or expense data, and other data relating to the loan. For example, a loan having $10,000 gross revenue may have a fee variable of 10% for the lead, 15% for processing the loan, 5% for each affiliate involved in the process, etc. Each percentage may further be broken down further by entity and parties entitled to the fee, step 515. For example, processing may be broken down to account for a lender's fee, the loan officer's involvement, etc. Reports can be generated relating to the loan and fee calculation, step 520. Examples of details incorporated in a report include, for example, loan revenue, profitability, cost effectiveness, e.g., according to various lead sources and strategies, revenue projections based on current leads and loans in process, adjusted for historical closing percentages for transactions at each stage, or other details relating to a loan transaction.

In one embodiment of the invention, the Accounting Module exports data to payroll systems to provide calculated commissions, bonuses, payout information and other accounting data for a relevant pay period. For example, the Accounting Module can export data to a base payroll system to provide payment to marketing partners or affiliates. The Accounting Module can also reconcile vendor or third party invoices with items ordered via the system, e.g., credit or title reports.

Rewards Program

The system may also provide a reward module that allocates rewards points for third party partners and affiliates. The program awards points for various levels of lead/loan generation (e.g., lead entered, application completed, etc.). The rewards points are redeemable for a variety of products and services. Reward status is accessible via the tracking features of the system. Examples of screens used to administer the reward program are depicted in FIGS. 37-39.

Systems and modules described herein may comprise software, firmware, hardware or any combination(s) of software, firmware or hardware suitable for the purposes described herein. Software and other modules may reside on servers, workstations, personal computers, computerized tablets, PDAs and other electronic devices suitable for the purposes described herein.

Software and other modules may be accessible via local memory, via a network, via a browser or other application in an ASP context or via other means suitable for the purposes described herein. Data structures described herein may comprise computer files, variables, programming arrays, programming structures or any electronic information storage schemes or methods or any combinations thereof, suitable for the purposes described herein. User interface elements described herein may comprise elements from graphical user interfaces, command line interfaces and other interfaces suitable for the purposes described herein. Screenshots presented and described herein can be displayed differently as known in the art to input, access, change, manipulate, modify, alter and work with information.

While the invention has been described and illustrated in connection with one embodiment, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A computer implemented method for processing loans, comprising:
receiving at least one lead relating to one or more individuals interested in obtaining a loan from a registered user;
storing data relating to the at least one lead in a database;
assigning the at least one lead to a loan officer, wherein the assigned loan officer is presented with an option to one of accept and decline the assignment;
reassigning the lead to another loan officer if a previous assigned loan officer declines the lead; and
tracking a status with regard to the loan application throughout a loan process.

2. The method of claim 1 wherein the lead is assigned to a loan officer automatically based on at least one parameter selected from the group consisting of location of property, location of at least one party, loan size, type of loan, completeness of lead, staffing, marketing partner obligations, franchisee obligations, and preferences provided by the user providing the lead.

3. The method of claim 1 wherein tracking the status of a loan comprises tracking whether the loan application has closed.

4. The method of claim 1 wherein tracking the status of a loan application comprises tracking at least one of: a time and date of each attempt to contact at least one relevant party, communications sent to relevant parties, communication received from relevant parties, credit checks, mailings, appraisal ordered, title ordered, appraisal received, title received, loan sent to processing, loan sent to underwriting, closing date set and approval status.

5. The method of claim 1 comprising communicating at least one of lead information and loan officer information to at least one party associated with the lead upon successful assignment of the lead to a loan officer.

6. The method of claim 1 comprising providing automatically a recommended loan product and loan pricing based on at least one of lead information and loan application information.

7. The method of claim 1 comprising preparing automatically at least one of a document and an application relevant to the loan.

8. The method of claim 7 wherein the application relevant to the loan comprises an order for at least one of a credit report, a title search, a property appraisal, a good faith estimate and a closing statement.

9. The method of claim 1 comprising assigning a fee variable to at least one aspect of a loan process and computing a fee due for the at least one aspect of the loan based on the fee variable.

10. The method of claim 9 comprising computing a fee for at least one of an individual and an entity entitled to at least a portion of the fee for the at least one aspect of the loan.

11. The method of claim 10 comprising exporting at least one of the computed fees to a payroll system for payment of the fee.

12. The method of claim 10 comprising generating at least one report comprising at least one of the fee computed for the at least one aspect of the loan, the fee for an individual entitled to a portion of the fee for the at least one aspect of the loan, and the fee for an entity entitled to a portion of the fee for the at least one aspect of the loan.

13. The method of claim 10 wherein the at least one report comprise at least one computation related to loan revenue.

14. The method of claim 10 wherein the at least one report comprises at least one computation related to loan profitability.

15. The method of claim 10 wherein the at least one report comprises at least one computation related to cost effectiveness regarding the loan.

16. The method of claim 1 wherein the lead is generated based on a determination that a refinance of the closed loan would be beneficial to a borrower of a closed loan.

17. The method of claim 16, wherein the determination is made based on a comparison of at least one term of the closed loan and at least one term of another loan.

18. The method of claim 1, wherein the lead is received from at least one affiliate website comprising at least one webpage with at least one form element therein for collecting information to generate the lead, wherein the affiliate website is one of a network of affiliate websites providing loan related services.

19. A method for web-based loan marketing, comprising:
receiving loan information of at least one closed loan, wherein the loan information comprises at least one term of the closed loan;
comparing the at least one term of the closed loan with at least one term of another loan;
determining based on the comparison whether a borrower of the closed loan would benefit from a refinance of the closed loan; and
generating a lead for a loan based on the determination.

20. The method of claim 19 wherein the at least one term of the closed loan and the other loan comprises an interest rate.

21. The method of claim 19 comprising communicating at least one message comprising a referral for the generated lead.
